(19) United States
(12) Patent Application Publication
(10) Pub. No.: US 2015/0045223 A1
(43) Pub. Date: Feb. 12, 2015

(54) BIOCIDAL COMPOSITIONS AND THEIR USE IN THE CONTROL OF MICROORGANISMS IN AQUEOUS AND WATER CONTAINING SYSTEMS

(71) Applicant: Gordon SHAW, (US)

(72) Inventor: Gordon Shaw, Johannesburg (ZA)

(21) Appl. No.: 14/385,255

(22) PCT Filed: Mar. 13, 2013
(86) PCT No.: PCT/ZA2013/000011

§ 371 Date: Sep. 15, 2014

(30) Foreign Application Priority Data
Mar. 16, 2012 (ZA) 2012/01970

(51) Int. Cl. A01N 33/12; A01N 33/18; A01N 33/04; A01N 43/80

(52) U.S. Cl. CPC A01N 33/12; A01N 43/80; A01N 33/18; A01N 33/04
USPC 504/160

(57) ABSTRACT

The invention provides a biocidal composition for controlling the growth of microorganisms in swimming pools and other aqueous systems. The composition includes: an antimicrobial substance for controlling microbial growth; an ionene polymer; and a synergist. The antimicrobial substance may be selected from the group consisting of: quaternary ammonium compounds such as cetylpyridinium chloride and benzalkonium chloride; isothiazolinone-derived compounds such as methylisothiazolinone; methylene bisthiocyanate; dibromonitrilopropionamide; and 2-bromo-2-nitropropane-1, 3-diol. The ionene polymer is preferably:

poly[oxyethylene(dimethyliminio)-ethylene(dimethyliminio)-ethylene)dichloride]. The synergist may be selected from the group consisting of triethanolamine, diethanolamine, ethanolamine, ethanol, and triethylamine. Preferably the synergist is triethanolamine.

### TECHNICAL FIELD

THIS INVENTION relates to biocidal compositions and their use in the control of microorganisms in aqueous and water containing systems. It relates also to methods of manufacturing such compositions.

### BACKGROUND ART

Sanitization of swimming pools and other bodies of water is important for the reduction of bacterial and algal residue not removed by filtration. Often this task is carried out by chlorination. Chlorine is effective against bacteria and viruses, as well as amoeba. As a replacement for the direct addition of chlorine to water, salt cells or hypochlorous acid generators (the so-called “saltwater system”) have been used in swimming pools.

Several alternatives to traditional chlorination exist and have been put into practice to varying extents, for example ozonation, disinfection with chloramine and UV disinfection (using ultra violet light).

There are disadvantages associated with the above methods, ranging from shortcomings in efficacy to cost and health concerns.

In the industrial field, many systems rely on water as a processing or cooling medium for efficient operation due to water's inert character, low cost and safety. However, water provides an ideal environment for the proliferation of micro-organisms. If left uncontrolled, these micro-organisms can cause significant problems leading to an increase in operating costs.

Water is also used as a heat transfer medium, whether in large recirculating cooling systems or smaller air-conditioning and humidifier units. Biofouling is problematic in these applications. Slime-forming organisms can form biofilms that provide ideal conditions for anaerobic bacteria to grow under the surface of the slime. A biomass of algae may form, causing problems.

In the oil and gas industry, unwanted microbial contamination can occur during drilling of wells, preparation of wells for production, construction of facilities and production itself.

In addition to the practical problems associated with microbial contamination, there is also a risk to human health.

Uncontrolled microbial growth presents numerous problems in multiple recreational and industrial settings. A need exists for a biocidal composition that can supplement the range of available treatments for swimming pools and other aqueous and water containing systems, with a view to eradicating or controlling microbial growth and the build-up of biofilms.

### DEFINITIONS

As used herein the term “antimicrobial” is intended to be interpreted broadly and shall, without limitation, include reference to compounds and compositions having at least one property selected from microbicidal, bactericidal, algaecidal, antiseptic and disinfectant properties.

As used herein the terms “biocide” and “biocidal” are intended to be interpreted broadly, and shall include reference to agents that can kill deter, render harmless or exert a controlling effect on harmful microorganisms.

For the purpose of this specification the meaning of “microorganism” includes, but is not limited to, bacteria, algae, fungi and viruses.

The words “control” and “controlling” are intended to be construed broadly so that they include within their meaning, without being limited thereto, inhibiting the growth or propagation of microorganisms, killing microorganisms, disinfection, and preserving against re-growth of microorganisms.

As used herein, the term “ionene polymer” is intended to be interpreted as a generic term referring to cationic polymers in which a substantial proportion of the atoms providing the positive, charge are quaternized nitrogens located in the main polymeric chain or backbone of the polymer rather than in pendant groups. Ionene polymers may be poly-ammonium salts formed through the reaction of diamines with dihalides. The term includes polymeric quaternary ammonium compounds, which as a class are distinct from the simpler, monomeric quaternary ammonium compounds.

For purposes of this specification the term “synergist” and derived words shall refer to an agent which may cause two or more components to exhibit performance, in respect of a given property or activity, that is more than additive of their expected individual performances for that property or activity at a given concentration in use. For example, a synergist may cause combined components to have improved biocidal properties than would otherwise be expected based on their individual performance at a given concentration in use.

However, for purposes of this specification, use of the word “synergist” in connection with a compound shall not be interpreted to mean that the compound concerned shall necessarily be capable of imparting, or shall, in use, impart, any such synergistic properties.

### DISCLOSURE OF INVENTION

According to a first aspect of the invention there is provided a biocidal composition for controlling growth of microorganisms in aqueous or water containing systems, which includes

an antimicrobial substance for controlling microbial growth in water-containing solutions;

an ionene polymer; and

a synergist.

The antimicrobial substance may be selected from the group consisting of:

biocidal quaternary ammonium compounds;

biocidal isothiazolinone-derived compounds;

methylene bisthiocyanate;

dibromonitrilopropionamide; and

2-bromo-2-nitropropane-1, 3-diol.

The quaternary ammonium compound may be cetylpyridinium chloride.

Instead or in addition, the quaternary ammonium compound may be benzalkonium chloride (“BAC”) (CAS Registry Number: 63449-41-2), having the following formula:

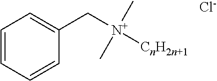

n=8, 10, 12, 14, 16, 18

The isothiazolinone-derived compound may be methylisothiazolinone.

The ionene polymer may be pre-selected for algaecidal properties.

A preferred ionene polymer is poly[(oxyethylene(dimethyliminio)-ethylene (dimethyliminio)-ethylene)dichloride] (CAS Registry Number: 31512-74-0), having the following formula:

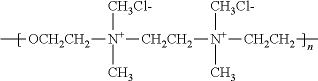

The variable n may be an integer ranging from 4 to 40.

The above ionene polymer is available under the trade name BUSAN® 77.

Through investigation and inventive insight, the Inventor has determined that an appropriate synergist may be selected from the group consisting of:
triethanolamine (CAS Registry Number: 102-71-6);
diethanolamine;
ethanolamine;
ethanol; and
triethylamine.

Of the above, triethanolamine (“TEOA”) is preferred as the synergist. This compound is a tertiary amine and a triol having the following formula:

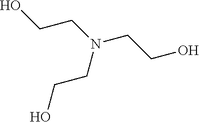

Other strong bases may be suitable as the synergist.

Turning to the ratios of the various components in the final composition, the following percentages apply:

The antimicrobial substance (for example the cetylpyridinium chloride, quaternary ammonium compound or methylisothiazolinone, etc.) may be present in the composition in a ratio of from 1% to 99% weight by volume, typically from 5% to 25% weight by volume, preferably approximately 100 g/L.

Taking the BAC quaternary ammonium compound as an example, a suitable commercially available product is “BAC 50”. This has a 50% concentration of the active ingredient and a density of ≈0.98 g/cm³ To achieve the final concentration of 100 g/L in a one-litre batch, the batch would be made up with a volume of 204.1 ml of BAC 50. (The calculation would be performed as follows: [100%÷50%]×100 g÷0.98 g/cm³=204.1 cm³). In cases where the commercially available active ingredient used is of a different concentration (e.g. where an 80% concentrate of BAC is used), the volume of ingredient used would have to be adjusted accordingly.

The ionene polymer may be present in the composition in a ratio of from 1% to 99% weight by volume, typically from 5% to 25% weight by volume, preferably approximately 120 g/L.

A suitable ionene polymer is provided by a commercially available product, BUSAN® 77. This is available in different concentrations but, as one example, can be obtained with a concentration of approximately 60% active ingredient and a density of ≈1.15 g/cm³. Using these figures, a one-litre batch of the biocidal composition would be made up with 173.9 ml of BUSAN® 77 to yield the 120 g/L of ionene polymer as active ingredient. (The calculation would be performed as follows: [100%÷60%]×120 g÷1.15 g/cm³=173.9 cm³).

The synergist may be present in the composition in a ratio of from 1% to 20% weight by volume, preferably from approximately 9% to approximately 11% weight by volume, for example 100 g/L.

The biocidal composition typically further includes water, which may be present in a ratio from 1% to 99% by volume, typically from 40% to 70% by volume.

The water containing system may, without limitation, be selected from the group consisting of residential and commercial swimming pools, baths, decorative ponds, spas, hot tubs, whirlpools, ornamental fountains, reservoirs, irrigation canals, treatment lagoons, small process water systems, water-makers (and other reverse-osmosis systems), storage tanks, waste-water systems, waterbed mattresses, cooling systems (e.g. cooling towers), recirculating systems, industrial air washing systems, metal cutting fluid circuits, fire protection systems, textile water systems, pulp and paper water systems, systems for oil and natural gas production operations, drilling muds, packing fluids, and generally any water containing systems involved in recreation-, leisure-, industrial-, commercial- and/or production processes where contamination by microorganisms can have adverse effects on, or consequences for, said systems or processes.

According to a further aspect of the invention there is provided a method of controlling microorganisms in an aqueous or water containing system, which includes treating the system with a biocidal composition as described herein.

In a further aspect of the invention there is provided a method of manufacturing a biocidal composition which includes the steps of
providing a quantity of water;
providing components comprising
   an antimicrobial substance for controlling microbial growth in water-containing solutions;
   an ionene polymer; and
   a synergist; and
mixing said components with said water, thereby to create an aqueous solution of said components in the water.

The components of the composition may be mixed with the water in the following order: firstly, synergist; secondly, ionene polymer; and thirdly, antimicrobial substance.

The components may be as hereinbefore described. They may be mixed with the water in quantities appropriate for yielding the relative ratios described hereinbefore for the biocidal composition.

### MODES FOR CARRYING OUT THE INVENTION

Embodiments of the invention will now be described by way of non-limiting example.

A biocidal composition is made up for controlling the growth of microorganisms in a swimming pool or other aqueous or water containing system. The composition includes the following primary components:
100 g/L of an antimicrobial substance in the form of a quaternary ammonium compound, for example benzalkonium chloride (“BAC”);
120 g/L of an ionene polymer, preferably poly[oxyethylene(dimethyliminio)ethylene(dimethyliminio)-ethylene)dichloride], commercially available under the trade names “BUSAN® 77” or “WSCP”;
100 g/L of a synergist, preferably triethanolamine; and
water.

Regarding the quaternary ammonium compound, BAC has been found to be particularly suitable for use in the biocidal compositions of the invention. BAC, also known as alkyldimethylbenzylammonium chloride or ADBAC, is a mixture of alkylbenzyldimethylammonium chlorides of various alkyl chain lengths. This product is a nitrogenous cationic surface-acting agent (surfactant). BAC solutions are fast-acting biocidal agents with a moderately long duration of action.

BAC is available from Acti-Chem S.A. (Pty) Ltd in a standard 50% concentrate under the trade name “ACTICIDE BAC 50 M” (Technical Name: Quaternary ammonium compounds, benzyl-C8-18-alkyldimethyl, chlorides). This 50% product is referred to herein as “BAC 50”.

Other quaternary ammonium compounds can serve as the antimicrobial substance. For example, the antimicrobial substance may comprise at least one quaternary ammonium compound selected from the group consisting of benzethonium chloride, cetalkonium chloride, cetrimide, cetrimonium, cetylpyridinium chloride, didecyl dimethyl ammonium chloride (“DDAC”), dofanium chloride, domiphen bromide, methylbenzethonium chloride and tetraethylammonium bromide.

Of these, cetylpyridinium chloride is preferred because of its low foaming properties.

The antimicrobial substance is not necessarily provided by a quaternary ammonium compound. Instead, for example, the antimicrobial substance may comprise at least one compound selected from the group consisting of:

biocidal isothiazolinone-derived compounds, for example methylisothiazolinone which is advantageous because of its low foaming properties;
methylene bisthiocyanate;
dibromonitrilopropionamide; and
2-bromo-2-nitropropane-1, 3-diol.

Regarding the ionene polymer, the product BUSAN® 77, which is available from Buckman Laboratories (Pty) Ltd in concentrations from 50% to 75%, has been found to be particularly suitable.

As regards the synergist, triethanolamine is a strong base which has been found to be suitable as a synergist. Other compounds can be used instead of triethanolamine, for example:
diethanolamine;
ethanolamine;
ethanol; and
triethylamine.

The biocidal composition may include, in addition to its primary components, further compounds and products selected from the group consisting of:
calcium control means;
inhibitors of scale formation;
inhibitors of metal accumulation;
clarifiers and/or flocculants;
shock means effective in initial start-up, for controlling odours, organic materials, contaminants and body oils; and
buffer means or other means for adjusting pH and alkalinity.

The following is an illustrative example of a method of manufacture of one embodiment of a biocidal composition according to the invention:
water is provided in a predetermined volume;
the water is stirred continuously;
triethanolamine is then added to the water and stirring is continued for 5 minutes;
BUSAN® 77 is added and the resultant solution is stirred for 5 minutes;
BAC 50 is added to the solution in a slow manner to inhibit undesirable colouration of the solution;
the solution is stirred for 10 minutes after introduction of all the components;
giving the biocidal composition, which is then packaged.

During the above, exemplary manufacturing process, the BAC 50, BUSAN® 77 and triethanolamine are added to the water in quantities selected such that they will be present in the final composition in ratios as hereinbefore described (for example: approximately 100 g/L BAC 50, approximately 120 g/L BUSAN® 77, and approximately 100 g/L triethanolamine as synergist).

The Inventor believes that the biocidal compositions disclosed herein present various advantages as compared with biocidal compositions available on the market.

For example, the combination of components as disclosed herein may be synergistic when used for microorganism control in aqueous or water containing systems. Such synergy may permit reduced amounts of active materials to be used to achieve acceptable biocidal properties, thus potentially reducing environmental impact and materials cost.

It will be understood by one skilled in the art that the biocidal compositions described herein can be applied to a wide variety of uses in different water containing systems. Therefore, although a primary mode of use will relate to purification of water in swimming pools, other modes of use of the compositions as biocides in industrial applications exist. For example, the compositions may be used to control slime and bacteria formation in water systems used at power plants, pulp and paper mills, in the oil industry, etc. These modes of use fall within the scope of this invention.

What is claimed is:

1-17. (canceled)

18. A biocidal composition for controlling growth of microorganisms in an aqueous or water containing system, which includes the following components:
(a) an antimicrobial substance selected from the group consisting of
biocidal quaternary ammonium compounds;
biocidal isothiazolinone-derived compounds;
methylene bisthiocyanate;
dibromonitrilopropionamide; and
2-bromo-2-nitropropane-1, 3-diol;
(b) an ionene polymer; and
(c) a synergist selected from the group consisting of triethanolamine; diethanolamine; ethanolamine; ethanol; and triethylamine;
characterized in that the ratio of component (a) to component (b) falls in a range from 0.6 to 1.5 and the ratio of component (a) to component (c) falls in a range from 0.7 to 1.3.

19. The biocidal composition as claimed in claim 18, which is an aqueous solution of:
component (a), the antimicrobial substance, present in a concentration range from 90 to 110 g/L;
component (b), the ionene polymer, present in a concentration range from 110 to 130 g/L; and
component (c), the synergist, present in a concentration range from 90 to 110 g/L.

20. The biocidal composition as claimed in claim 18, in which the quaternary ammonium compound is cetylpyridinium chloride.

21. The biocidal composition as claimed in claim 18, in which the quaternary ammonium compound is benzalkonium chloride having the formula: 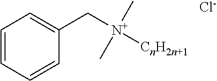
n=8, 10, 12, 14, 16, 18

22. The biocidal composition as claimed in claim 18, in which the isothiazolinone-derived compound is methylisothiazolinone.

23. The biocidal composition as claimed in claim 18, in which the ionene polymer is poly[(oxyethylene(dimethyliminio)-ethylene (dimethyliminio)-ethylene)dichloride], having the formula: 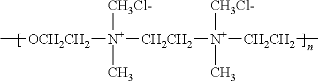
in which the variable n is an integer ranging from 4 to 40.

24. The biocidal composition as claimed in claim 18, in which the synergist is triethanolamine.

25. The biocidal composition as claimed in claim 18, which is an aqueous solution of:
(a) benzalkonium chloride (BAC) (CAS Registry Number: 63449-41-2);
(b) poly[(oxyethylene(dimethyliminio)-ethylene (dimethyliminio)-ethylene) dichloride] (“WSCP”; “BUSAN 77”) (CAS Registry Number: 31512-74-0); and
(c) triethanolamine (“TEOA”).

26. A method of controlling microorganisms in an aqueous or water containing system, which comprises providing a biocidal composition of claim 18 and adding said biocidal composition to said aqueous or water containing system.

27. A method of manufacturing a biocidal composition which includes the steps of:
providing a quantity of water;
providing components comprising
(a) an antimicrobial substance selected from the group consisting of
biocidal quaternary ammonium compounds;
biocidal isothiazolinone-derived compounds;
methylene bisthiocyanate;
dibromonitrilopropionamide; and
2-bromo-2-nitropropane-1, 3-diol;
(b) an ionene polymer; and
(c) a synergist selected from the group consisting of triethanolamine; diethanolamine; ethanolamine; ethanol; and triethylamine; and
mixing said components with said water such that the ratio of component (a) to component (b) falls in a range from 0.6 to 1.5 and the ratio of component (a) to component (c) falls in a range from 0.7 to 1.3, thereby to create an aqueous solution of said components in said water.

28. The method of manufacturing as claimed in claim 27, in which
component (a), the antimicrobial substance, is selected from the group consisting of benzalkonium chloride, cetylpyridinium chloride, and methylisothiazolinone; and
component (b), the ionene polymer, is poly[(oxyethylene(dimethyliminio)-ethylene (dimethyliminio)-ethylene)dichloride].

29. The method of manufacturing as claimed in claim 28 in which the components of the composition are mixed with the water in the following order: firstly, the synergist; secondly, the ionene polymer; and thirdly, the antimicrobial substance.

30. The method of manufacturing as claimed claim 27 in which the components are mixed with the water in quantities appropriate for yielding the following concentrations:
component (a), the antimicrobial substance, present in a concentration range from 90 to 110 g/L;
component (b), the ionene polymer, present in a concentration range from 110 to 130 g/L; and
component (c), the synergist, present in concentration range from 90 to 110 g/L.

31. A method of controlling algal and bacterial growth in swimming pool water, comprising the steps of:
providing a composition as claimed in claim 18,
wherein the ratio of components (a) and (b) to one another is effective to control algal and bacterial growth in said swimming pool water; and
adding said composition to said swimming pool water.
